(19) United States
(12) Patent Application Publication
(10) Pub. No.: US 2007/0041582 A1
(43) Pub. Date: Feb. 22, 2007

(54) Methods and systems for enabling users to inject sound effects into telephone conversations

(76) Inventor: Bin Wai Lam, La Mesa, CA (US)

Correspondence Address: JLB CONSULTING, INC.;c/o INTELLEVATE, P.O. BOX 52050, MINNEAPOLIS, MN, 55402, US

(21) Appl. No.: 11/504,890

(22) Filed: Aug. 16, 2006

Related U.S. Application Data
(60) Provisional application No. 60/710,236, filed on Aug. 22, 2005.

(51) Int. Cl. H04M 1/00

(52) U.S. Cl. 379/908; 379/441

(57) ABSTRACT

Methods and systems enable a user to inject sound clips from an audio device into a telephone conversation. The invention includes an adapter that connects to an audio player, a user listening device, and a communication device such as a telephone. In different embodiments, these connections may be wired, wireless or a combination of both. The audio player is selectable and of the type wherein stored audio clips can be changed, for example an MP3 player, CD or DVD player, video player, computer or the like. In operation, the user selects an audio clip from the audio device for substantially immediate and simultaneous playback through the user listening device and the telephone. In this manner, both the user and any other party to the telephone conversation can hear the audio clip substantially simultaneously.

### CROSS REFERENCE TO RELATED APPLICATIONS

The present application is related to co-pending application Ser. No. 11/455,558 filed Jun. 19, 2006. This application claims the benefit of Provisional application Ser. No. 60/710,236 filed Aug. 22, 2005.

### FIELD OF THE INVENTION

The present invention relates generally to audio communications and more specifically to methods and systems for enabling the injection of sound clips into audio communications.

### BACKGROUND OF THE INVENTION

The use of mobile phones and other portable communications devices has increased tremendously in recent years. Similarly, media players such as MP3 player and the like have grown in leaps and bounds. American teenagers are believed to chat on the phone, on average, 7.7 hours each week, while teenage girls may account for a much higher phone usage.

Unless you are a comedian, folly artist, or an animation film voice-over talent, it's a challenge to create special sound effects just using your voice and/or any available materials.

Many different kinds of headphones, hands-free devices, and adapters exist. They are all designed to function as either a hands-free communications device for phones, a headset for listening to music through a device such as MP3 or CD players, or an adapter to convert one plug or jack to another. Many hands-free devices and headphones are adding more and more features like Bluetooth for wire-free communications, integrated FM or AM radio, retractable cord for tangle-free operation. And, in the case of adapters, many of them are simply allowing the user to convert one type of plug or jack to another type to make an extension.

Recent, some adapters have been developed for alerting user of incoming phone calls, while the user is listening to music on an MP3 player, by sending an audio signal (beep or other type of alert sound) to the user's headphone and/or automatically pausing his music playing. Better yet, some adapters allow a user to answer a call or talk on the phone without removing the headset. Likewise, many portable media devices such as MP3 players have been developed and marketed, but they are all designed as a mean for listening to music and other audio materials, with a few exceptions including functionalities like built-in digital camera, FM radio, voice recorder, Wi-Fi ready, calendar and photo viewing. There is a trend in the consumer electronic business to converge devices. For example, mobile phones are converging with cameras, MP3 players, and the like. Convergence may reduce the number of devices a consumer is required to carry, but may also motivate consumers to unnecessarily discard functional devices and invest in the unnecessary expense of the new devices.

Some companies have attempted to integrate cellular phone and MP3 players into a single device, while others have continuously improved on headphones and hands-free devices. All these inventions operate satisfactorily for their purposes, but none of the aforementioned inventions teach the use of sound effects with a phone and media player, and more particularly, such apparatus and method to allow users to quickly and easily hook up both media player (e.g., MP3 player) and communications devices (e.g., phone) for injecting sound clips and sound effects into phone conversations.

FIGS. 1A-1C illustrate the audio paths for several devices of prior art where A represents audio signal from user's voice (from hands-free's microphone), B represents signals from the two-way communications device such as cellular phone, and C represents audio signals produced by an external media player, e.g., MP3 player or the like as well as any built-in components.

FIG. 1A is a typical hands-free device 120, including a single earset or a pair of headphone 220 for receiving audio signals B from a communications device 280 such as a corded phone or cellular phone, consisting of a microphone 210 for converting a user's voice to electrical signals A. Wires are joined together into an integrated standard plug, e.g., 2.5 mm plug, or other proprietary plug for transmitting the user's voice 250 to the communications device 280 and from the communications device 280 to 252 user's headset 220.

FIG. 1B illustrates a “Personal Portable Integrator for Music Player and Mobile Phone,” an invention filed by Richard P. Alden of Park City, Utah in October 2004 (U.S. patent application: 20040198436). According to the patent specification, this “integrator” 130 is used to integrate the services of an arbitrary audio delivery such as an MP3 player or other media player 270 with the services of an arbitrary two-way communications device 280. The “integrator” 130 receives and provides input and output signals from both the audio delivery device 270 and the two-way communications device 280, thereby enabling a user to listen to music or other audio material and receive and place phone calls on a mobile phone simultaneously. Simply put, the “integrator” 130 receives audio signal C 254 from media player 270 and signal B 252 communications device 280 then transmit 258 it to the user's headset 220 with the option to hear 256 either signal C from media player 270, signal B from communications device 280, or the combined signals B+C from both devices 270, 280. This invention does not allow any people the user is on the phone with to hear the audio materials (signal C) that are playing on his media player. Only audio A, which is generated from the user's microphone 210, is transmitted 250 to the voice path of the communications device 280, hence, only the user's voice (or any sound picked up by the hands-free mic) is audible to the other party or parties on the phone. Therefore this invention is not suitable for injecting audio clips or sound effects into phone conversations, voice mail, recorded greeting message, etc.

FIG. 1C illustrates the audio path of Phonebite's RAZZ Headset 140. When a user presses the designated button on the Razz Headset 140, it generates one of the ten preprogrammed, unchangeable sound bites C1-C10 transmitting the sound bite to 256 the integrated earset 220 and the voice path 258 of user's phone 280. Hence the triggered sound can be heard by both the user and the other party or parties on the phone conversation simultaneously. On 256, the user may hear audio B (audio or voice produced from the other line 252), audio C (sound bites C1-C10 generated by the Razz Headset device 140), or the combination of B and C. Through 258, the person(s) on the other line may hear audio A (user's voice or any sound transmitted 250 by user's microphone 210), audio C (sound bites C1-C10 generated by the Razz Headset 140), or the combination of A and C.

FIG. 1D shows Phonebite's RAZZ Headset 160 (140 as described above). It is basically a hands-free headset with an integrated in-line mechanism with ten fixed sound bites. Like all standard headsets, it equipped with a microphone 166, a single speaker earpiece 168, and a 2.5 mm plug 170 for phones. The user needs to rotate the scrolling wheel 164 to locate a sound effect he desires, then press the front 162 of the wheel (which functions as a PLAY button 162) to trigger the sound, in turn, the audio signals are sent to the voice path of the phone, for the other party to hear, and to the user's own earset. Therefore the played sound clip is audible to both the user and all parties on the phone conversation. With the Razz Headset 160, consumers may not replace or install new sound clips to the device nor can a user record his own message or sound to use as a sound clip. When the user is bored with the ten sound effects, the device does not serve much value to the user anymore.

The present inventors have recognized that what is needed are apparatuses and methods for linking a media player, e.g., MP3 player and the like, to a phone to enable a user to inject sound effects into phone conversations, voice mails, greeting messages, etc.

### SUMMARY OF THE INVENTION

The present inventor has invented apparatuses and methods for linking up a phone and media player to enable users to inject sound clips and sound effects from the media player into phone conversations, the sound effects including voice mails, greeting messages, etc.. Other functions enabled by the present invention include manipulations and distortion of a user's voice as well as enabling other party(s) on a phone conversation to hear a particular song, audio book, or any other audio content on the user's media playback device, such as portable MP3, CD, MD, and the like players.

The present invention enhances phone conversations. It enables, when talking to friends or family, the pressing of a button to inject an “applause” sound to congratulate their accomplishments. It enables a user to create a door knocking sound effect followed by pre-recorded audio of “Any one there?” when your friend is not with you or about to fall asleep during the phone conversation. It enables answering the phone with Bug Bunny's famous line “What's up doc?” or with Lionel Richie's song clip “Hello! Is it me you're looking for?” Or the use of Arnold Schwarzenegger's popular quote “I will be back . . .” from the Terminator movie when asking the other party on the phone to hold while you are picking up another incoming call. The possible sound enhancements are virtually endless. Different kinds of special sound effects of your choice can be injected into phone calls to make conversations more fun, vivid, and creative.

The present invention is much less expensive than buying an entire separate device to recognize these benefits and advantages.

### BRIEF DESCRIPTION OF DRAWINGS

These and other objects, features and advantages of the present invention will now be apparent from a consideration of the following Detailed Description Of The Invention, when considered in conjunction with the drawing figures, in which:

FIGS. 1A-1C are block diagrams illustrating prior art.

FIG. 1D is a plan view of a prior art device.

FIG. 2 is a block diagram illustrating audio paths in accordance of one embodiment of the invention.

FIGS. 3A-3B are perspective views of an all wired device in accordance of one embodiment of the invention.

FIG. 3C are perspective views of an alternative embodiment of an all wired device with detachable headset plug.

FIG. 3D are graphical illustrations of interchangeable faceplates in accordance of one embodiment of the invention.

FIG. 4A is a pictorial view illustrating an alternative embodiment of an all wired in accordance of one embodiment of the invention.

FIG. 4B is a pictorial view illustrating an alternative embodiment of part-wired, part-wireless in accordance of one embodiment of the invention.

FIG. 4C is a pictorial view illustrating an alternative embodiment of an all wireless device in accordance of one embodiment of the invention.

FIG. 5A is a pictorial view illustrating a wireless embodiment of the invention.

FIGS. 5B-5D are block diagrams showing variations of audio paths of different embodiments in accordance with the invention.

FIGS. 6A-6C are block diagrams illustrating different configurations of the adapter device configuration in accordance with the invention.

FIG. 7 is a block diagram illustrating a process of using the invention.

FIGS. 8A-8C are pictorial views illustrating different designs of the adapter device in accordance with the invention.

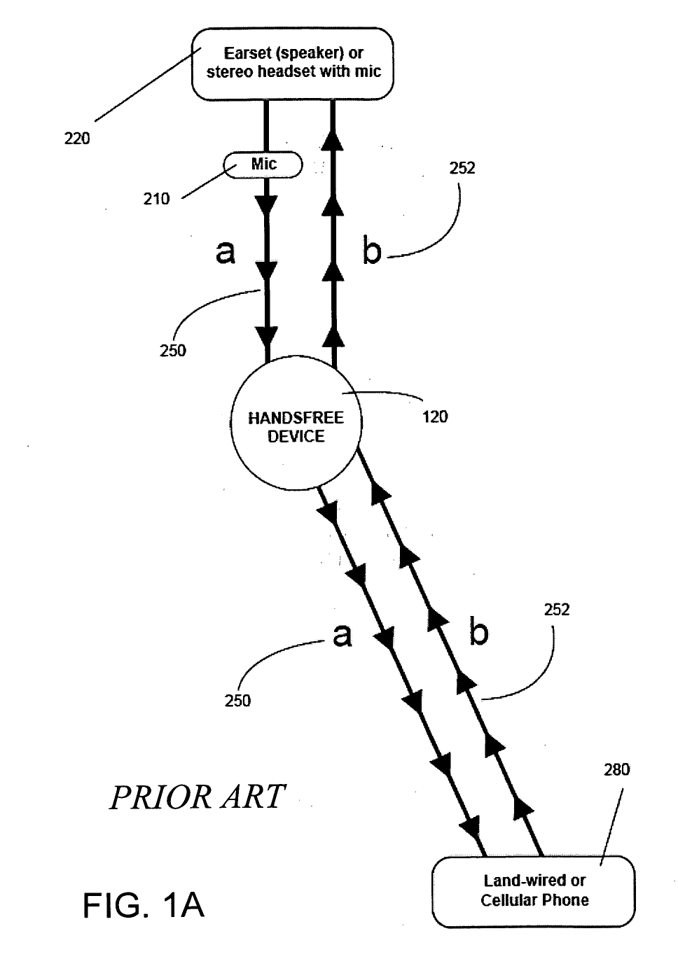

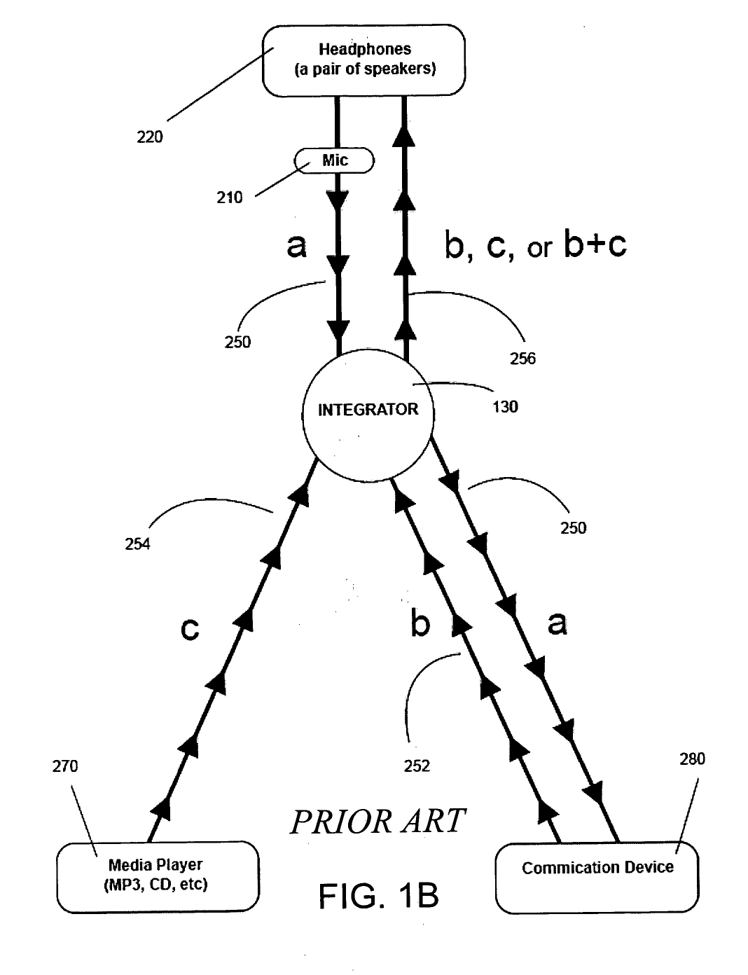

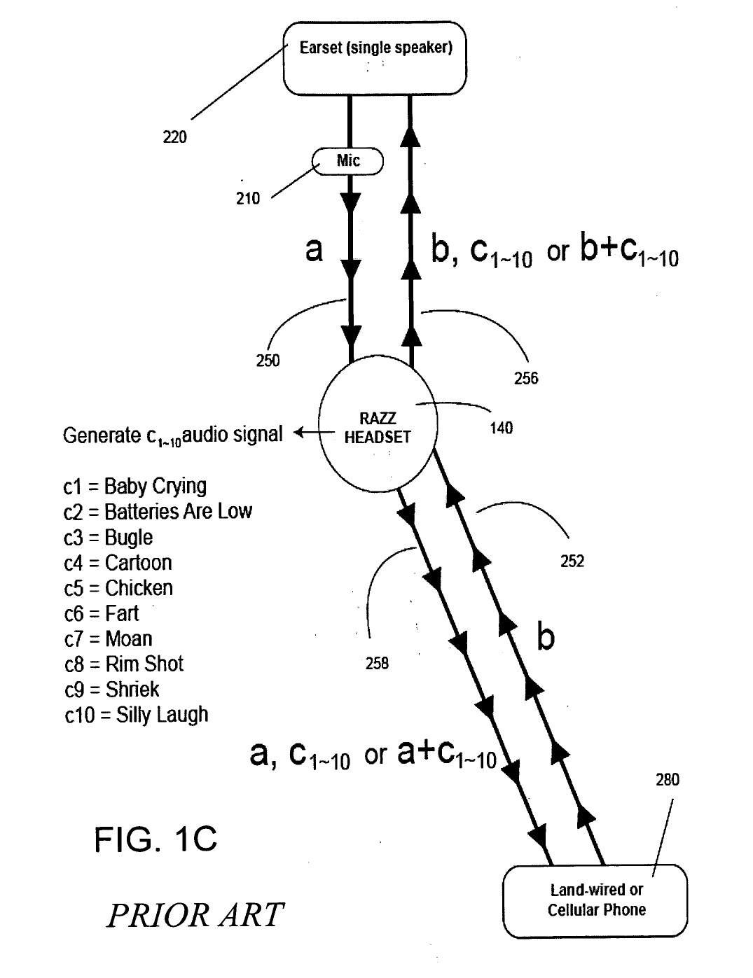

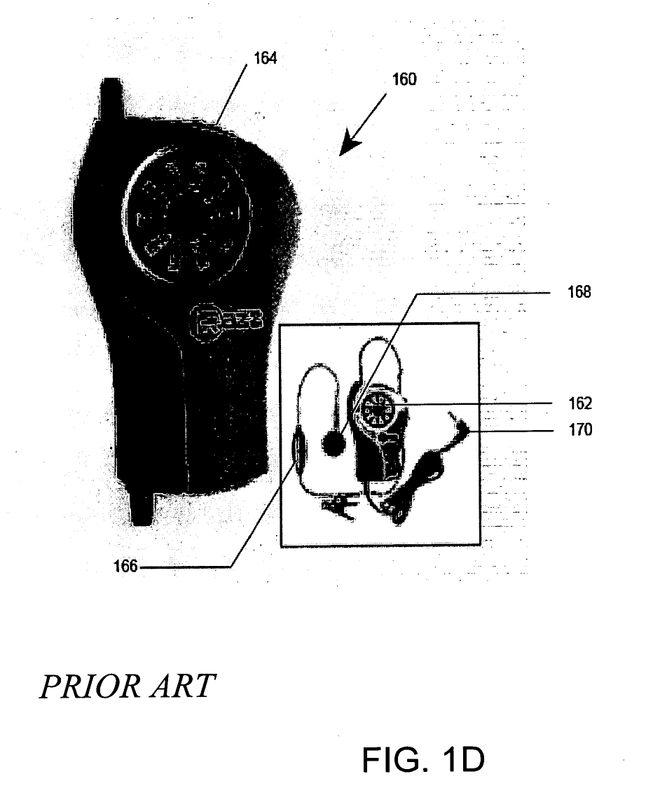

### DETAILED DESCRIPTION OF THE INVENTION

The present invention comprises methods and apparatuses for assisting a user to inject one or more sound clips into a phone conversation(s) using a media playback device such as an MP3 player or the like.

The invention provides entertainment and amusement, which will not interfere with phone conversations, which can incorporate audio, songs and sound effects of user's choice according to the moment of thought. The invention has commercial value by being amusing, entertaining, unusual, and capable of producing a surprise effect and fun, creative phone conversations.

As used herein, examples and illustrations are illustrative in nature and not limiting.

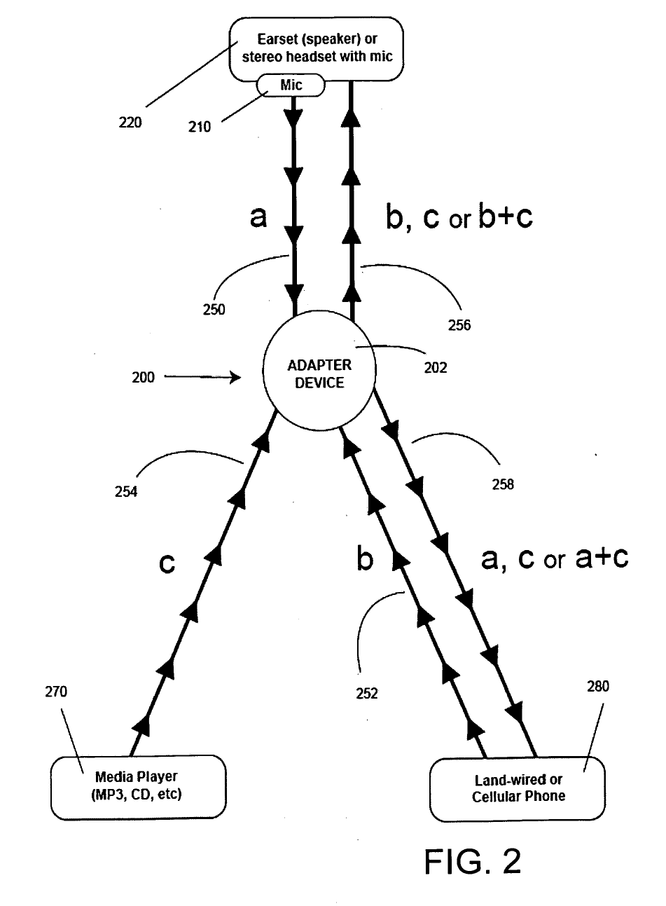

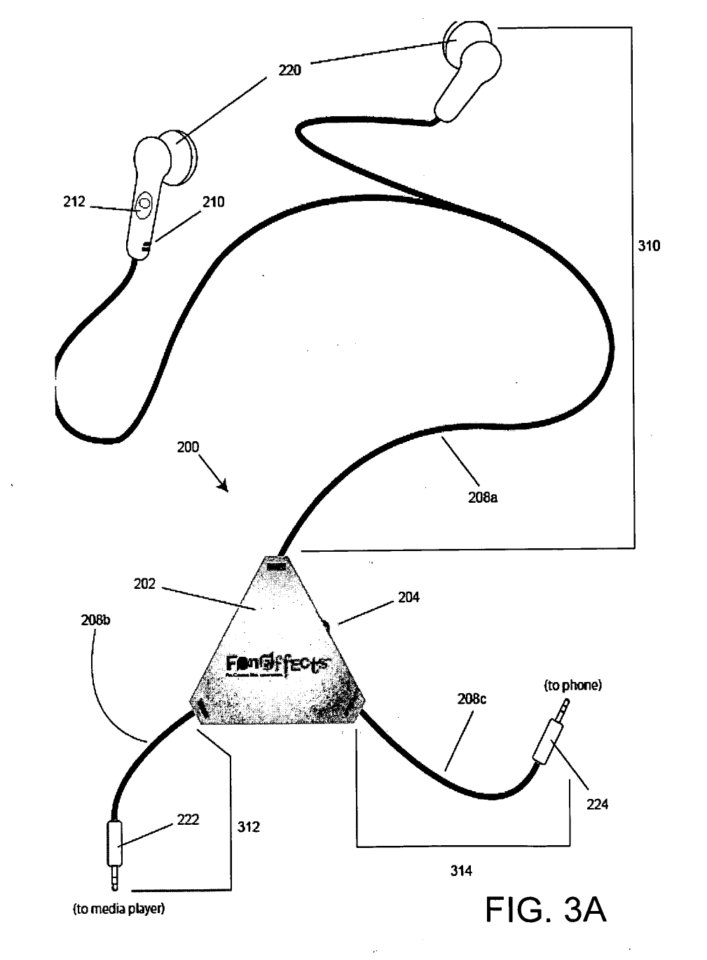

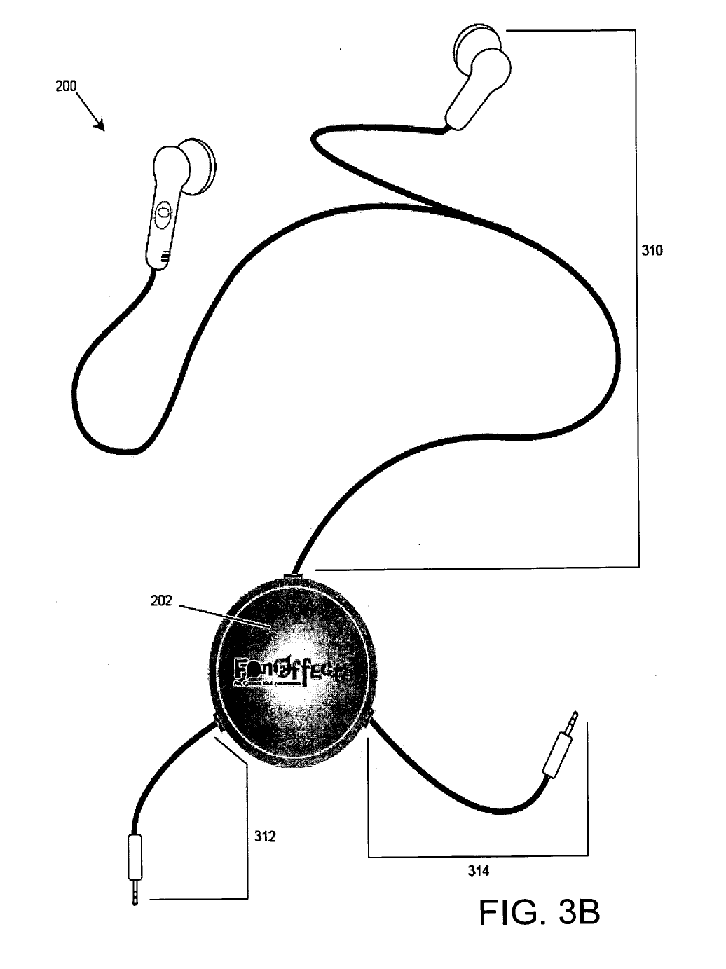

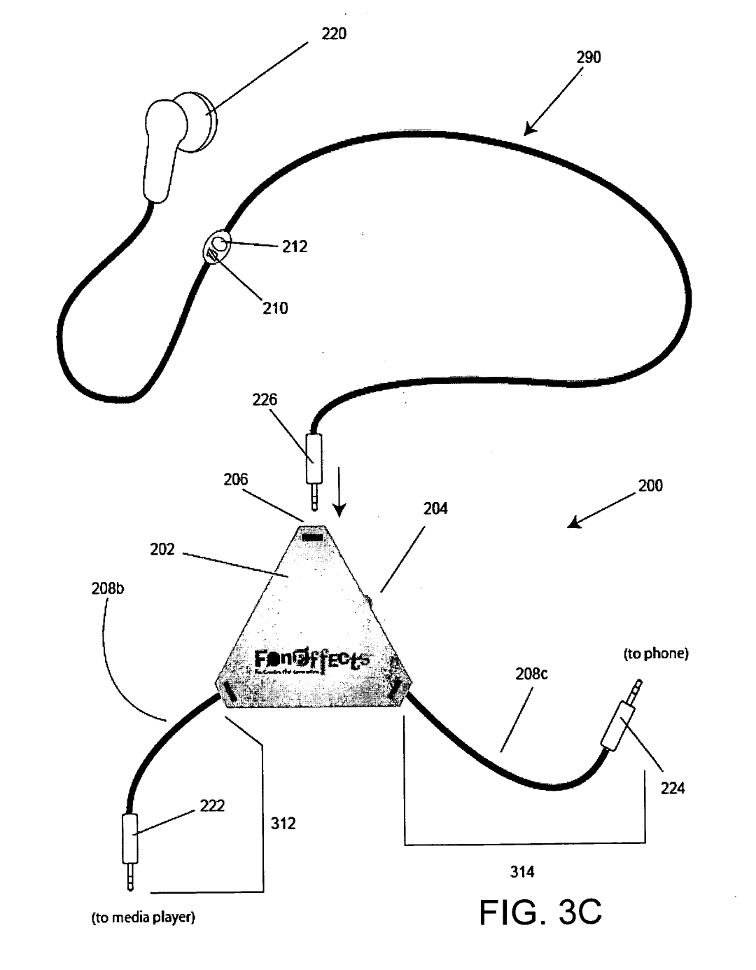

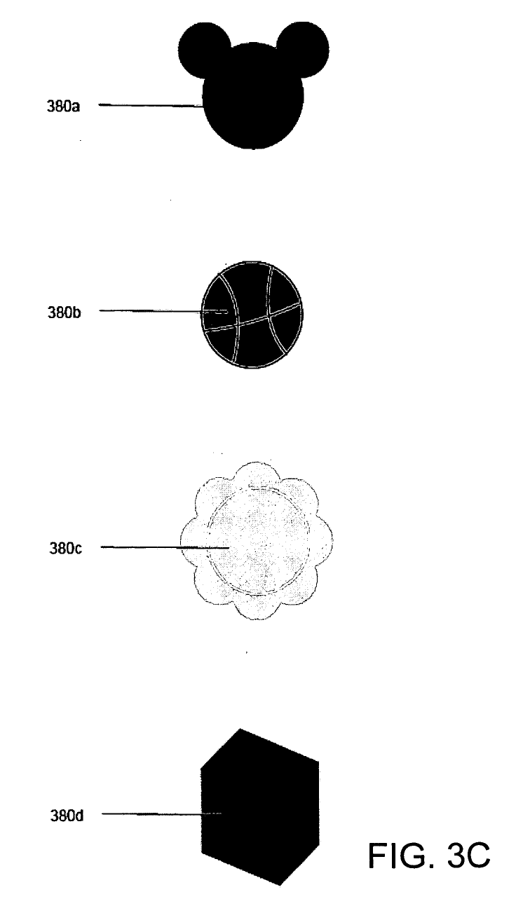

With reference now to FIGS. 2, 3A, 3B and 3C, the adapter device 200 may include a first electrical plug 222 connected to receive 254 audio signal C from the media player 270, such as MP3 player and the like, a second electrical plug 224 connected to receive 252 audio signal B from a communications device 280 such as a land-wired or cellular phone, and a detachable or integrated hands-free unit 220 with a microphone 210 to transmit a user's voice, hence producing 250 audio signal A. The various plugs 222, 224 are connected to the adapter device via wires 208b and 208c. In turn, the adapter device 200, independent from the media player 270 and two-way communications device 280, mixes and combines the audio signals comprising signal C and B, the combination of the two then transmitted 256 to the user's hands-free device 120 such as earset or headphones 220 with the integrated microphone 210. Concurrently, audio signal A or signal C or the combination of both are then transmitted 258 to the voice path of user's communications device 280, consequently, the other party or parties on the phone able to hear signal A, C, or A+C simultaneously.

It will thus be seen that the present invention transmits audio signals from the user's media player 270, not just to the headset or hands-free device 220 which is only audible to the user, but also that such audio signals are sent to the telephone or cellular phone 280 where the other party or parties can hear the audio signals generated by user's media player during a phone conversation.

Accordingly, FIG. 2 illustrates audio paths in accordance with one embodiment of the invention. Audio signal C from the audio playback device 270, e.g., an MP3, DVD, MD, CD, and the like media player, may be selectively transmitted 254 to either the user's hands-free headset 220 or both the headset 220 and communications device 280 such as a cellular phone. In the embodiment, when the user speaks, his voice is transmitted 250 (through a mic 210) and the executed audio clips from the media player 270 are also transmitted 252 to the adapter 200. In turn, the adapter device 200 mixes and transmits signals A+C 258 to the communications device's voice path while the user still hears signal C produced 254 from the media player 270. The signal 258 could be signals 254 from the media player 270, the user's voice 250 (or any sound picked up by the microphone 210), or the combination of 254 and 250. Simultaneously, the user hears signal B (voice and sound) transmitted 252 from the other party or parties on the phone line along with the signal C generated 254 by his media player 270. Hence, signal 256 could be signal B from phone 280, signal C from media player 270, or the combination B+C of both devices 270, 280. If no audio material is played on the media player 270 or if it's in the mute or pause mode, the user will only hear signal B from the communications device 280 when the other party (or parties) speaks. Alternatively, if no signal B is generated or the other party (or parties) on the phone is silent, the user will only hear signal C produced from his media player 270, only if an audio file is played. Through 250, in accordance with one embodiment of the invention, signal A may transmit more than just sound generated by the user's microphone 210. For instance, signal A may carry instruction signals produced by a switch or button to answer/end a call, redial the last called number, etc.

In certain embodiments, the adapter device 200 may include a mixer (not shown) to mix audio signals originating from the media player 270, phone 280, and mic 210. Thus, the audio signals may be heard simultaneously by the user through a headphone or hands-free device 220. In certain instances, a ring tone or other alert sound may be generated to indicate an incoming call and may be audible over the played sound clips through the headset or hands-free device 220. FIGS. 3A-3C show various embodiments of the wired adapter of the present invention. One embodiment selected to illustrate the invention comprises four parts: a case 202 to house the wires and all necessary components of the invention, a connection 312 to the media player 270, a connection 314 to phone 280, and a hands-free unit 310 as shown on FIG. 3A. Embodiments shown on FIGS. of 3A and 3B are identical with the, exception of their appearances—the outer case 202 for housing the invention. The case 202 on FIG. 3A is triangular while on FIG. 3B it is round. These are just two examples to illustrate many different variations. The case 202 could be any form, size, color, finish, etc. and could be made with any materials. In a particular embodiment, the case 202 is shaped by a thin hard plastic material for housing retractable mechanisms (not shown), cables 208a-c, earset(s) 220, and any other required components. The retractable mechanism, in this example, consists of a spring loaded spool as represented by a coil or any mechanism for retracting a cable, cord, or wire and permitting extension of at least part of it. Cables 208a-c attached to the adapter device 202 are retractable; hence user can enjoy a tangle-free experience. To unwind the cables, the user can simply grab each of the plugs 222, 224 and the headsets 220 and pull the cables 208 out to a desired length. To retract a specific cord, the user can simply press the designated lever button (not shown) on the adapter casing 202, pull it until the retractable mechanism is triggered (usually it requires the user to pull the entire length of the cable), or any other method or mechanism is employed.

Cable 314 includes a first end for connection to the adapter's center unit and a second end 224 for connecting to the communications device 280. Both ends are connected by a cable 208c. The second end 224 of the cable is provided with a standard three terminal audio plug for connection to a standard three terminal audio jack of a communications device 280 such as a phone. The audio plug 224 has three electrical contacts including contacts for signal transmitting, signal receiving, and ground. In certain embodiments, the plug might have more than three electrical contacts due to transmitting stereo audio or other electric signals. The audio plug may be a standard 2.5 mm mono or stereo plug 224, which is known to be used for land-wired telephone and mobile phones, or any other type of plugs (not shown). In alternative embodiments, other plugs and plug converters (not shown) may be employed instead.

Connector 312 also includes a first end for connection to the adapter's center unit 202 and a second end 222 which comprises a standard three terminal audio plug for connection to a standard three terminal audio jack of a media player 270 such as an MP3 device. The audio plug 222 has three or four electrical contacts including contacts for signal transmitting and ground. The audio plug 222 may be a standard 3.5 mm stereo plug, which is commonly employed in media playing devices such as MP3, CD, MD, and the like players, or another type of plugs. Both plugs 222, 224 are attached to cables that can be extended from and retracted into housing unit 202.

In certain embodiments, the case 202 houses an audio mixer, volume controller(s), a voice manipulation processing unit, and/or any other feature-enhancing components. Said device has three openings for the retractable cables 208 in certain embodiments. One opening for a 2.5 mm plug (or any plug for phones) and its cable 208b, and another for a 3.5 mm plug (or any plug for media players) and its cable 208c. The openings are formed for the user to easily and comfortably pull the plugs 222, 224 out with a finger, whereby to use the adapter device 200 even if the cables are completely retracted. In certain embodiments, a single earset or a pair of stereo headphones 220 of a hands-free device is attached to the cable(s) 208A that can be extended from and retracted into housing 202, which contains the shape of an earset or a pair of earsets molded on the side for convenient storage of the earset(s) 220. Apertures are large enough to allow easy passage of the cables but small enough for the earset(s) and 2.5 mm and 3.5 mm plugs to abscond.

The hands-free unit 310 comprises a single or a pair of earbuds 220 that consists of a mini speaker(s), with an integrated microphone 210 to convert user's voice sound to electrical signals for transmitting the signals to the two-way communications device 280. An optional switch 212 may be included as part of the hands-free unit 310 for sending instructional signals to the communications device 280 such as to answer/end a phone call. In certain embodiments, this switch 212 may include other functionalities such as redialing and other enhanced features. This multi-function switch 212 may be in any shape and size, hence, it may be a depressable button integrated with the earbud 220 or the cable 208a. The adapter device 200 may also comprise an integrated volume controller(s) 204 for adjusting the output of volume generated by the media player 270 and/or phone 280. Volume controller(s) 204, multi-function switch 212, microphone 210, all may be integrated into the adapter casing 202 or positioned on the hands-free cable 208a or on the earbud as part of the hands-free unit. In certain embodiments, one of the earsets (Left or Right earbud) may be muted or reduced in volume level when the phone call is active. Otherwise, both earsets are audible to the user when enjoying music listening. Accordingly, the adapter device 200 may include a first electrical plug 222 connected to receive 254 audio signal C from a media player 270, such as an MP3 player and the like, a second electrical plug 224 connected to receive 252 audio signal B from a communications device 280 such as a cellular phone, and a detachable or integrated hands-free unit 220 with microphone 210 to transmit the user's voice, hence producing 250 audio signal A. The plugs 222, 224 are connected to the adapter device via connectors or cables 208b and 208c. In turn, the adapter device 200, independent from the media player 270 and two-way communications device 280, mixes and combines the audio signals which consist of either signal C or B or the combination of the two and transmit them 256 to the user's hands-free device 120 such as earset or headphones 220 with an integrated mic 210. Concurrently, audio signal A or signal C or the combination of both is transmitted 258 to the voice path of the user's communications device 280, consequently, another party or parties on the phone can hear signal A, C, or A+C simultaneously.

The plugs 222, 224 and cables 280 may be eliminated for wireless connections or substituted with jacks for connecting with external, detachable cables on certain embodiments of the invention. In addition, the type of plugs and jacks may vary for different embodiments.

FIG. 3C illustrates an embodiment of the invention with the hands-free device 290 as a separate, detachable unit; hence this particular embodiment comprise three parts rather than four: a case 202 to house the wires and all necessary components of the invention, connection 312 to media player 270, and connection 314 to phone 280. With this configuration, substituting the integrated hands-free free unit 310, a standard 2.5 mm jack 206 or any other type of jack is constructed on the adapter device 202 which enables users to use their own hands-free device 290 having a compatible plug 226. Users may also use a plug converter (not shown) to connect any hands-free device to the adapter 202 if its plug is incompatible with the employed jack on the adapter device 202. In this version, the adapter device comprises more or less the same components: volume controller(s) 204, cables 208b, 208c and plugs 222, 224, case 202, retractable mechanism (not shown), etc. The independent hands-free device 290 includes all common elements such as microphone 210, earbud 220, plug 226, and an optional multi-function switch 212. In certain embodiments, the adapter 200 may include a mute button for the user to disconnect audio signals from media player 270 by pressing the switch while he receives or places a call or for other reasons. At anytime, the user may trigger the switch again to regain audio signals from the media player 270. In another embodiment, a switch or button or control device may be included to control features of the phone 280 and/or media player 270. Such features include, but not limited to, a volume controller, a mute functionality, a call connected and disconnected command, or the like. In particular embodiments, audio from media player 270 is automatically muted when an incoming phone call is detected.

The casing 202 can be any shape, size, and form and may be produced with any materials and any colors and texture. FIG. 3D provides some examples of an interchangeable faceplate for use on the casing. It should be noted that for sake of simplicity, only one type of faceplate is shown corresponding to the case used on FIG. 3B. With licensing from Disney™, the faceplate can be a silhouette of Mickey Mouse™380a. Baseball 380b, golfball (not shown), and football (not shown) faceplates as well as other sport symbols are available for sport fans. Flower 208c and other object faceplates 208d are also available. These interchangeable faceplates can be any design, including silhouette or detailed images, 2D or 3D element, and can be created with any materials and designs.

Although the invention has been illustrated with cables 208a-c for connection from and to the adapter's central unit 202, the cables 208a-c may be eliminated in favor of wireless devices, such as bluetooth-enabled mobile phones and headsets, and a wire-free connection may be used. The adapter device 200 transmits and receives audio signals through an all-wired configuration in certain embodiments while in other embodiments, the device 200 communicates wirelessly with phone 280 or hands-free device 220 or both 280, 220 using Bluetooth, Ultrawide band (UWB), or other wireless technologies.

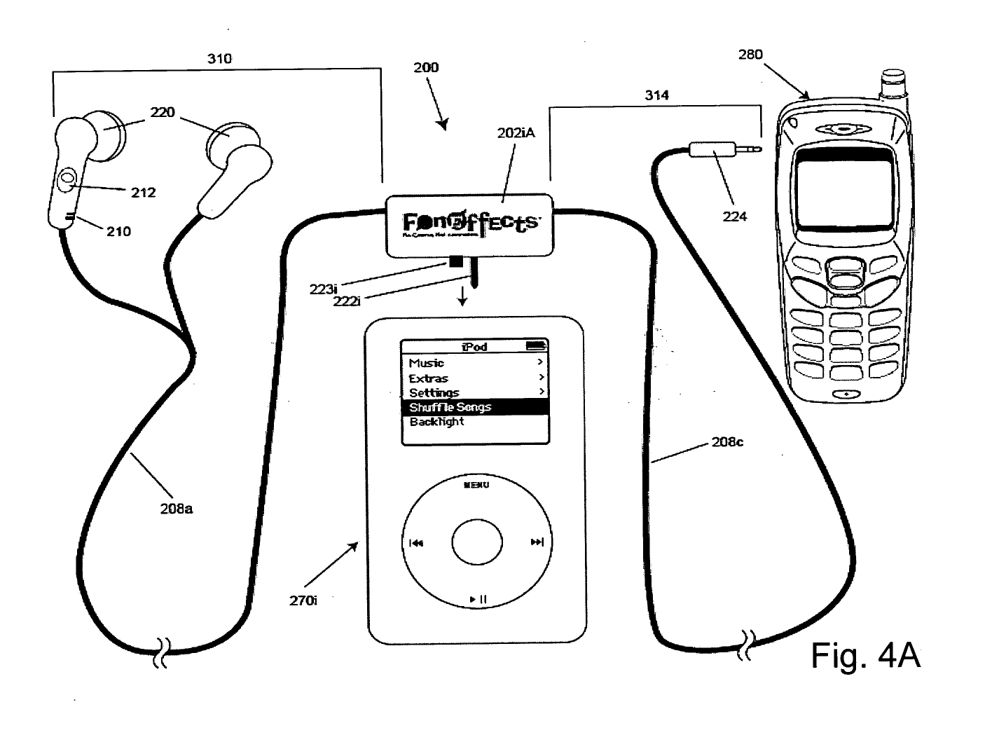

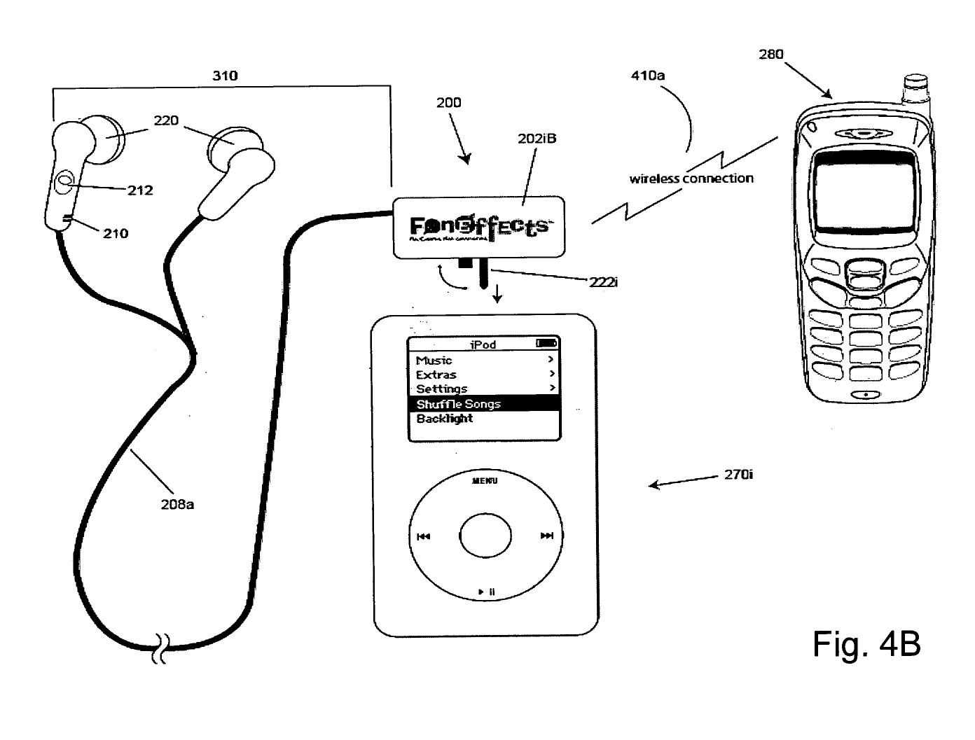

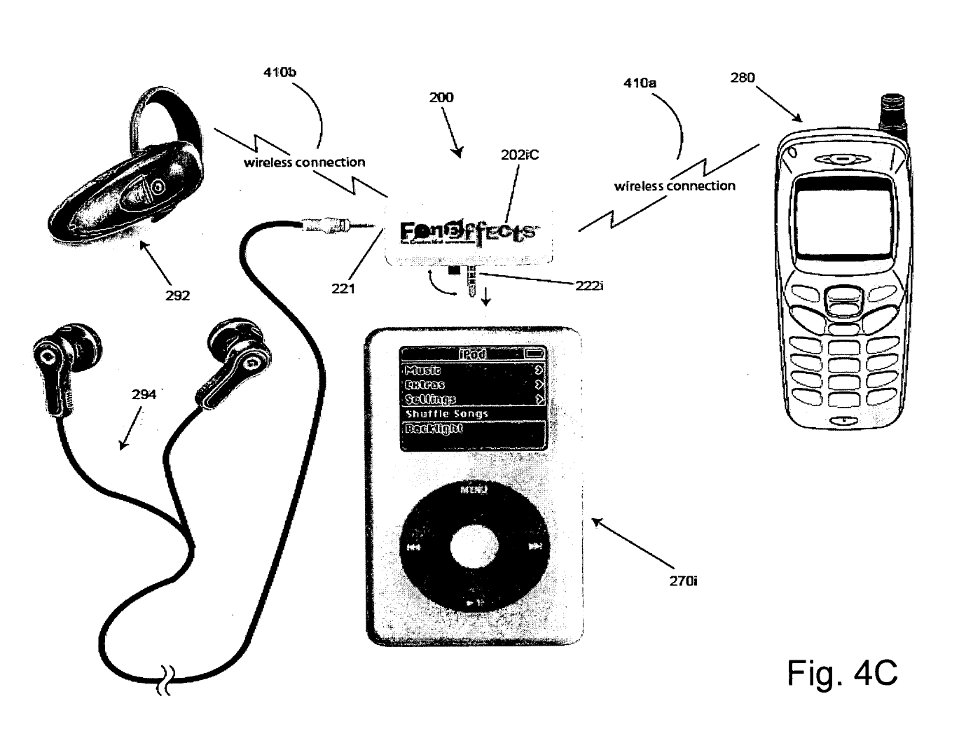

FIGS. 4A-4C show an alternative embodiment of the invention tailored to Apple's iPod 270i consumers. Accordingly, the functionality and components of the embodiment shown on FIG. 4A is similar to those of FIG. 3A. Other than a slightly different and compact case 202iA for housing the invention, it also comprises four parts: a case 202iA to house the wires and all necessary components of the invention, connection 222i to the iPod 270i, connection 314 to phone 280, and the hands-free unit 310. The hands-free unit 310 includes a cord 308a, an optional multi-function switch 212, microphone 210, and earbuds 220. A plug 224 is attached to cord 308c for linking the adapter 202iA with the phone 280. Appropriately, connector 312 is eliminated in this version, substituting a 3.5 mm stereo plug 222i fastened to and housed on the adapter device 200 for connecting to the iPod 270i. Although with this configuration, a power source is not necessary for operation, a small square plastic cotter 223i next to the audio plug 222i is included for fitting on the iPod 270i. Hence, it enables the adapter device to be attached firmly to the iPod device 270i without swerving as it would if the adapter device consisted only of a round 3.5 mm plug 222i. In certain embodiments, the cotter 223i is made with different material for drawing power from or transmitting other electrical signals to and from the iPod 270. Both cables 208a, 280c for the hands-free unit 310 and plug 314 may be designed with retractable mechanisms housed inside the case 202iA. Alternatively, the hands-free unit 310 may comprise a single or pair of earsets 220.

FIG. 4B shows a partial wired and partial wireless embodiment 202iB. It is very similar to the version shown on FIG. 4A with 314 eliminated and substituted with wireless connections 410a, using Bluetooth, UWB, or the like technologies. FIG. 4C shows an all-wireless embodiment of the invention 202iB. Both hands-free unit 310 and the cord 314 connecting to phone 280 are eliminated and substituted with wireless connections 410a, 410b. The link 410a between the phone 280 and adapter 202iC and the link 410b between the wireless hands-free device 292 and adapter device 202iC may be employed using Bluetooth, UWB, or other wireless technologies. With this version, a 3.5 mm jack 221 may be included on the adapter device 202iC for use of external, independent wired stereo headphone 294, should the user want to listen to stereo music or other audio materials. Having the same configuration as those on FIGS. 4A and 4B, the cotter 223i and 3.5 mm plug 222i may be foldable on this adapter device 200, which can be turned clockwise to hide inside the casing 202iB when not in use.

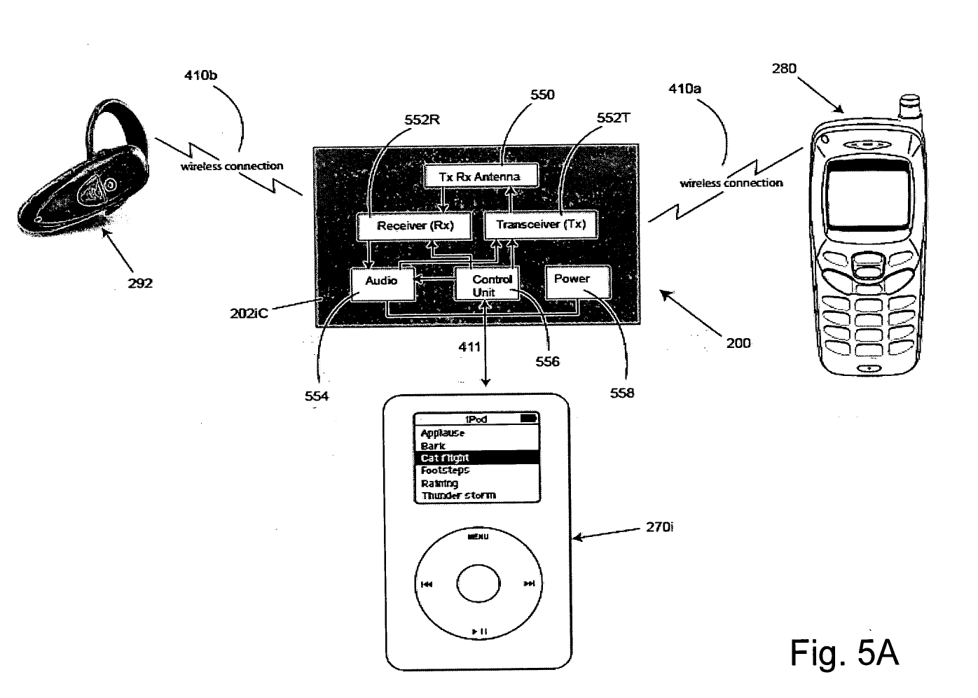

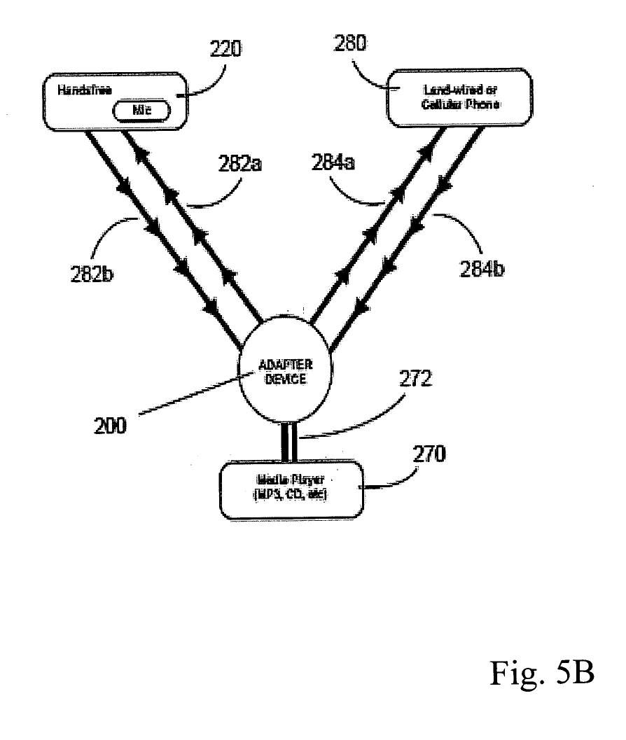

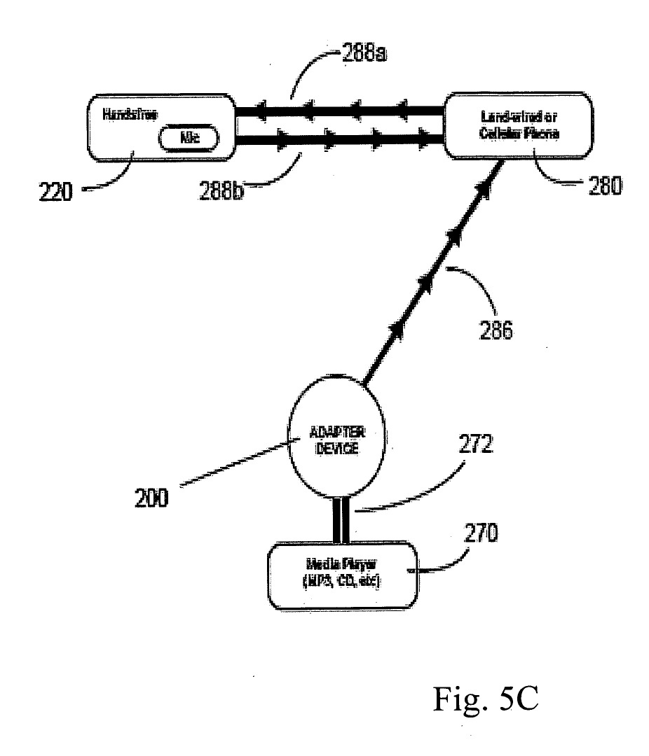

FIG. 5A illustrates a wireless adapter device in accordance with an embodiment of the invention. This embodiment 200 could be designed for Apple's iPod 270i or any other media players. It links to the phone 280 and wireless headset 292 through wireless connections 410a and 410b, respectively. The connection 411 between the adapter device 202iC and the media player 270i may simply be a standard 3.5 mm plug or a wireless connection should the media player 270i employ such capability. On certain embodiments, the adapter device 200 comprises: a case 202iC housing components such as an antenna 550, receiver (Rx) 552R, transceiver (Tx) 552T, audio processor 554, control unit 556, and power source 558. Alternatively, more than one antenna 550, receiver (Rx) 552R, and transceiver (Tx) 552T may be employed on certain embodiments. Audio processor unit 554 may include, but is not limited to, an audio mixing module, a Digital Signal Processing (DSP), and/or a Digital Analog Convertor (DAC), etc.

FIGS. 5B-5D illustrate different variations of audio paths between the three devices: adapter 200 attached to the media player 270, hands-free headset (with mic) 220, and phone 280. FIG. SB shows the connections for both hands-free 220 and phone 280 connected through the adapter device 200 which acts as the central hub. Audio signals 272 from media player 270 are transmitted 272 to the adapter device 200 via direct connection through a 3.5 mm connector or other plug. In certain embodiments, the transmission 272 of audio clips could be sent using wireless technologies such as Bluetooth, UWB, etc. In turn, the adapter device 200 transmits any audio signals 272 from the media player 270 to both the hands-free device 220 and phone 280. The signals 282a to the hands-free headset 220 could be just the audio 272 from media player 270, audio 284b from the phone, or the combination of 272 and 284b. Similarly, signal 284a to the phone 280 could be just audio 272 from the media player 270, audio 282b from the hands-free's 220 microphone (user's voice), or the combination of 272 and 284b.

FIG. 5C illustrates another embodiment in which the phone 280 is the central hub having two-way communications 288a, 288b with the hands-free headset 220 and receiving 286 audio signals from the media player 270 through the adapter 200. Audio signals 272 from the media player 270 go through the adapter device 200 and are then transmitted 286 to the phone 280. Consequently, the phone automatically and instantly sends 288a the same signal to the headset 220 as well as transmits it to the voice path of user's phone 280; thus, the other party or parties on the phone conversation hear the identical audio clip, as the user, that is played from the user's media player 270. Signals 288a going to the headset 220 could be just audio 272 from media player 270, audio from phone 280, or the combination. Audio 288b from user's microphone is only sent to the phone, not to the media player.

Alternatively, as FIG. 5D reveals, the hands-free device 220 may operate as the central hub having two-way communications 292a, 292b with the phone 280 and receiving 290 audio signals 272 from the media player 270 through the adapter 200, in turn transmitting such signals 292a to the phone 280. Signals 292a could be simply the user's voice generated through the microphone, sound 272 from the media player 270, or the combination of the two. Signal 292b is simply audio signals from the phone 280, such as voices or sounds from the other party or parties on the phone conversation or signals such as call alerts, message alert, or any other signals generated by the phone itself.

The indicated signal paths 272, 282a-b, 284a-b, 286, 288a-b, 290, 292a-b are connections between devices and they could be wired, wireless, or a combination of both.

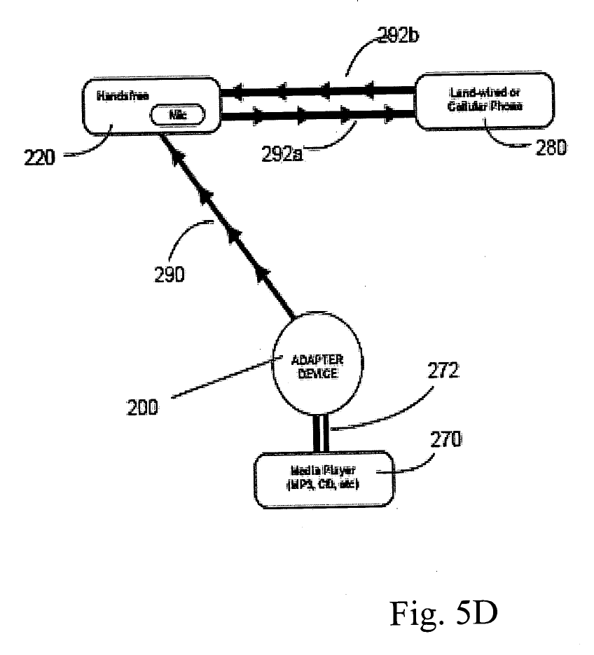

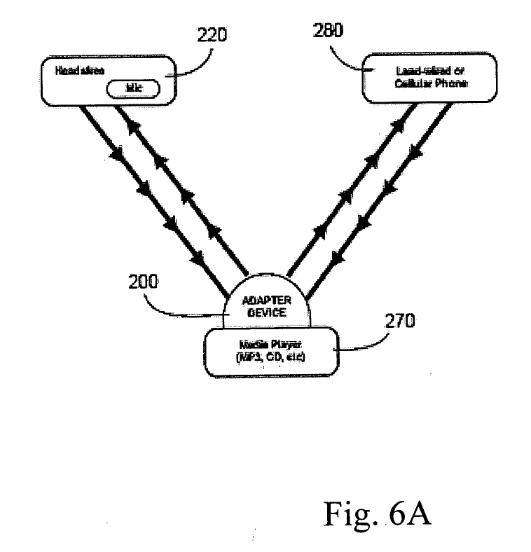

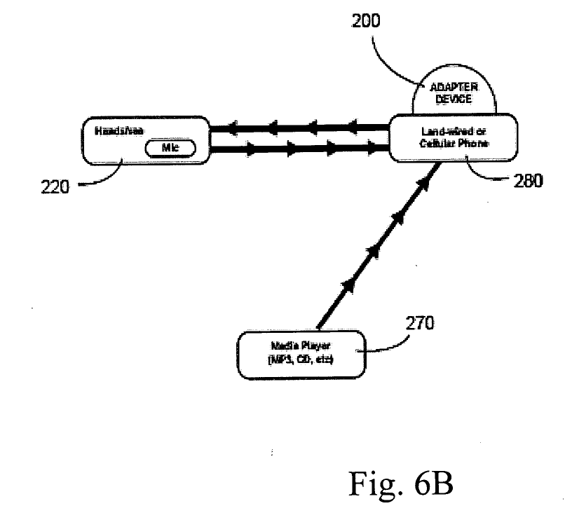

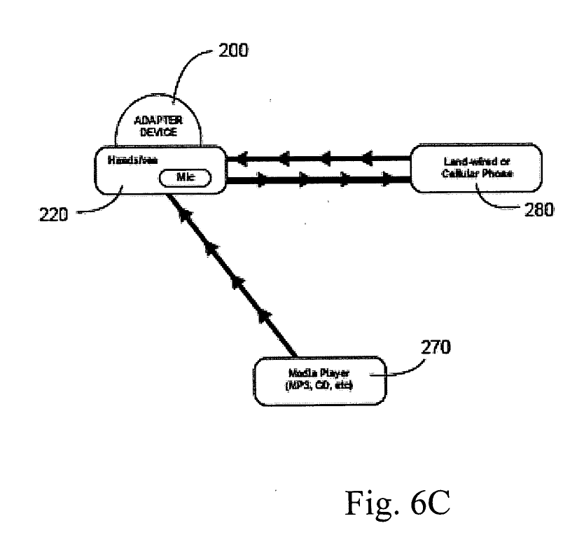

FIGS. 6A-6C present different configurations of how the invention can be applied. In certain embodiments, the adapter device 200 can be removably attached to or embedded in the media player 270 as shown on FIG. 6A. In other embodiments, the adapter 200 may removably attached or built into the two-way communications device 270, such as a telephone or cellular phone as illustrated on FIG. 6B, or it may be integrated on the hands-free device 220 which is shown in FIG. 6C. The present invention may be embodied in other specific forms or configurations without departing its spirit or essential characteristics and functionality. The described embodiments are to be considered in all respects only as illustrative, not restrictive.

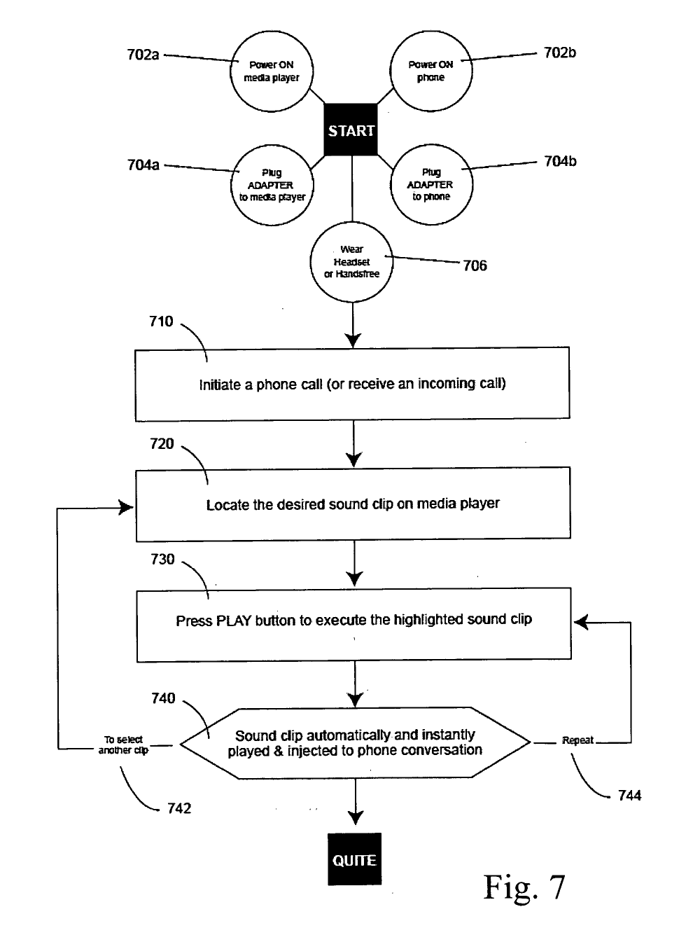

FIG. 7 is a flowchart 700 illustrating a particular process 700 for using the adapter device 200 to inject sound clips from a media player 270 into phone conversations in accordance with an embodiment of the invention. Accordingly, to start, user needs to POWER ON the media player 702a and phone 702b (assuming they were turned off) then connect the adapter by PLUGGING the cables to the media player 704a and phone 704b. In certain embodiments, 704a and 704b could be eliminated when using a wireless version of the adapter device 200 such as Bluetooth, or others as described above. Pairing of wireless devices, such as Bluetooth devices, is required in a conventional manner for a first time use. Next, at 706, the user puts on the hands-free unit or headset 220. In some embodiments, such as wireless headset 292 configuration, the user also needs to POWER ON the headset device as well as perform the necessary pairing for first time use.

With the power turned on and the connections made, the user is ready to inject sound clips into phone conversations after initiating or receiving a phone call 710. Please note the order of steps 702a-b, 704a-b, 706, and 710 can be performed in any sequence. To inject a particular sound clip, the user needs to locate the desired sound clip 720, then PRESS PLAY 730 on the media player 270 to activate that audio file. In turn, as shown at 740, the executed audio file will be heard instantly and simultaneously by the user as well as the other party or parties on the phone conversations. The user may also inject a particular sound clip into voice mails, voice greeting messages, etc. The steps required to locate the desired sound clip 720 varies from device to device and depends on the setting and configuration of the individual's media player 270. After injecting the chosen sound clip, the user may repeat the played file 744 by pressing the PLAY button or any designated button again 730. Or he can select another sound clip 742 to be injected to the conversation by locating 720 the clip he had in mind.

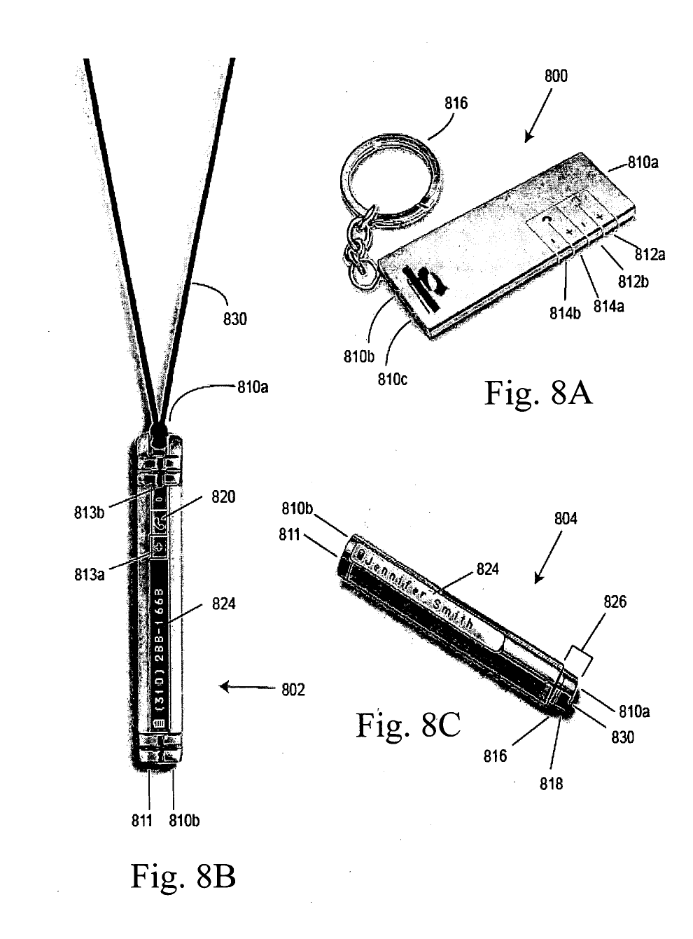

FIGS. 8A-8C illustrate several different designs in accordance with different embodiments of the invention. FIG. 8A shows one embodiment of the wired adapter device 800. This device consists of three jacks: a 2.5 mm mono or stereo jack 810a for connecting the hands-free headset, a 3.5 mm stereo jack 810b for connecting the adapter 800 to a media player 270, and a 2.5 mm jack 810c (or other proprietary jack) for two-way communications with a phone 280. In this particular embodiment, there are also four keys (buttons) for volume controlling. The user may press 812a to increase the volume and 812b to lower the volume on his headset. Similarly, he may press 814a and 814b to increase or reduce the volume of an audio clip that is played, respectively. The controllers 814a, 814b are only for the audio clip, which can be heard by both the user and the other parties on the phone conversation, while the controllers 812a, 812b are for the volume level that is only noticeable to the user only. The illustrated embodiment is, of course, in a key chain configuration.

FIG. 8B illustrates an embodiment of a partial wired, partial Bluetooth adapter device 802. It also has a 2.5 mm mono or stereo jack 810a for connecting to a hands-free headset and a 3.5 mm stereo jack 810b for connecting the adapter 802 to a media player 270 but the 2.5 mm jack 810c for communicating with the phone 280 is substituted with a wireless (Bluetooth) connection. However, in this configuration, it includes a grey scale or color LCD 824 for displaying a caller ID and other relevant information and an internal rechargeable power source (not shown). Additional port 811 for recharging the built-in battery is included at the bottom of the adapter. The buttons 813a, 814b are dual controllers for volume level for both the hands-free headset and the audio clip output to the communications device 280. To toggle back and forth between controlling the volume for the headset and the audio clip, user needs to press the multi-function button 820 twice consecutively. The LCD display 824 may reveal the current selection as well as a battery level indicator and other information on the screen 824.

In this particular embodiment, to ANSWER or END a phone call, the user presses the multi-function button 820 once. To POWER ON or OFF the adapter device 802, the user presses and holds the multi-function button 820 until the action is triggered. Pressing and holding the button 820 for three seconds activates a pairing service for this device with a Bluetooth-enabled phone. In certain embodiments, the user may press the multi-function button 820 three times consecutively to call up the menu, then navigate the menu choices with the volume control buttons 813a, 813b to move back and forth, pressing the multi-function button 820 once again to select the displayed function or feature while on the menu setting. For instance, pressing the multi-function button 820 three times consecutively, the first menu item (e.g., BASS) is displayed. To navigate to and view the next menu item, the user presses the (+) button 813a which will display TREBLE, and press the (+) button 813a again to show another item, and, so on. Eventually the menu selections will loop back to the first item. Menu choices may vary for different embodiments. Some may include the basic sound level adjustments such as BASS while other may comprise Preset Equalizer functions and other advance enhancement features. Although device 802 can be worn as a pendant as shown on the FIG. 8B, it can be carried as a key chain too. The device may be packaged with an integrated loopset (headset with mic) with lanyard 830. On some embodiments, jack 810a may be eliminated and substituted with a built-in retractable stereo headset with microphone.

The particular embodiment 804 shown in FIG. 8C is similar to the one in FIG. 8B. It is also a partial wired, partial Bluetooth adapter device consisting of one 2.5 mm mono or stereo jack 810a for connecting to a hands-free headset and one 3.5 mm stereo jack 810b for connecting the adapter 800 to a media player 270. Like the embodiment 802 shown in FIG. 8B, a port 811 for recharging the built-in battery, a color or grey scale LCD display 824, and an eyelet 830 for attaching a lanyard or keychain ring are also included in this embodiment 804. However, instead of employing a flat button 820, a multi-function button in cap 826 is used. Similarly to the embodiment 802 show in FIG. 8B, pushing the end of the cap 826 in once will activate the ANSWER/END CALL function. To TURN ON or OFF the device, the user pushes and holds the cap 826 until in the action is triggered. The user may perform a pairing service of the adapter device 804 and the two-way communications device 280 by pushing and holding the cap 826 for three seconds. The cap 826 consists of two controls in barrels 816, 818 of which the top barrel 818 controls the volume level of the hands-free headset and the bottom barrel 816 is for adjusting the volume of audio clip that is audible to both the user and other party or parties on the phone conversation. The user simply turns the barrels 816, 818 to one direction to increase the volumes and to the opposition direction to lower the volumes. Like as described with respect to device embodiment 802, the cap may be pushed two or three times consecutively to trigger other functionalities, i.e., menu selections and other advance features on certain embodiments.

In other wireless embodiments, the 3.5 mm jack for linking to the media player 270 may be eliminated and substitute with bluetooth or other wireless technology.

The present invention may be embodied in other specific forms or configurations without departing its spirit or essential characteristics and functionality. The described embodiments are to be considered in all respects only as illustrative, not restrictive.

REVIEW—BASIC OPERATION

In order to use a particular wired embodiment of the wired adapter device, a user needs to connect (plug in) the 2.5 mm plug to the 2.5 mm jack of his land-wired or cellular phone and the 3.5 mm plug to the jack of his CD, MP3, or Media Player. He then powers up his media playing device and dials the phone number of the person he wants to call. The user can easily extend the cable of the hands-free headset to insert an earset or earsets onto his ear(s) for a phone conversation or listening to music or audio clips from his media player.

At anytime during the phone conversation, the user may play an audio clip (track) from his media player. An audio clip can be a song, a short sound bite of sound effects, an extract of a movie scene, a quote, a slogan, or a self recorded message—any audio signal on the user's media player. Audio will pass from media player through the wire connected with the 3.5 mm plug to the adapter device, which then transmits the audio to the headset and to the cellular phone through the 2.5 mm plug.

When not using the phone, the user may use this adapter device to listen to music or any other audio materials from his MP3 player, CD player, or any other audio playing device that uses a 3.5 mm plug.

The adapter device can be compact, light, and easily clipped to a shirt's vertical opening (placket front), a pocket, a pulse, a backpack, and the like. The adapter of the present invention is economical, easy to use, fashionable to wear and carry, creates surprising effects and enhances conversations with fun and creative outcomes.

SUMMARY OF STRUCTURAL AND FUNCTIONAL EMBODIMENTS

An apparatus for assisting phone user to play and inject sound effects to phone conversations quickly and easily using a portable media player, such as a MP3 player and the alike, and two-way communications device, such as a mobile phone or landwired phone, comprising four parts:

the adapter and its wires and necessary components housed in a case;

connection to the media player;

connection to the two-way communications device; and

connections to a hands-free unit.

The apparatus as above, wherein the connections may be wired, wireless, or simply substituted with audio jacks for connecting external, detachable cables that link with the portable media player, phone, and/or hands-free device.

The apparatus as above, wherein the media player can be any devices with audio playback capacity.

The apparatus as above, wherein the two-way communications device may be a land-wired telephone, cellular phone, or any other communications devices.

The apparatus as above, wherein the hands-free unit may be a typical mono hands-free device with one earbud, a stereo hands-free headset with two earbuds, or any other acoustic devices with a voice transmitter such as a microphone, attached.

The apparatus as above, wherein wireless connections could be Bluetooth, UltraWide Band (UWB), or other wireless technologies.

The apparatus as above, wherein audio jacks may be used to substitute the integrated cables and plugs as well as the hands-free device.

The apparatus as above, wherein jacks and plugs may be mono or stereo and may be 2.5 mm, 3.5 mm, or any other types or a combination as long as the they are compatible with the phone, media player, hands-free device, and the adapter device.

The apparatus as above, wherein adapter casing may be any shape, size, color, and material built. The apparatus as above, wherein adapter casing further including optional apertures for retracting cables and well as to store the earset or earsets.

The apparatus as above, wherein adapter casing further including a hook or eyelet for lanyard or key ring, thus user can wear it as a pendant or carry it as a key chain or in anyway user desired.

The apparatus as above, wherein adapter casing may further including interchangeable faceplates which allows users to personalize their adapter device.

The apparatus as above, wherein adapter casing further including one or more buttons or switches for triggering the desired voice manipulation function on certain embodiments.

The apparatus as above, wherein hands-free device can be an integrated unit or a removably-attached external device.

The apparatus as above, wherein hands-free device can be connected via wired or wireless. The apparatus as above, wherein hands-free device further including one or more multi-function buttons or switches.

The apparatus as above, wherein hands-free device may automatically muted on one of the earbuds for stereo earsets embodiment during phone calls.

The apparatus as above, wherein the adapter device optionally further comprising: An audio mixer, retractable mechanisms for storage of the cables, volume controllers, components for enabling voice manipulations, and any other advance features.

The apparatus as above, wherein the multi-function buttons as well as microphone as above and volume controllers as above can be integrated on the adapter casing, hands-free's earbud, on the cable, or place anywhere deems to be appropriate.

The apparatus as above, wherein voice manipulations including, but not limited to, raising, lowering, cartoonizing, and robotizing user's voice as well as converting a man's voice to woman voice and vice versa, and impersonating user's voice to certain celebrity, cartoon, or any other characters.

The apparatus as above, wherein the adapter device may further comprising a built-in processor, RAM, ROM, and/or other type of digital memory as well as any other necessary components for performing voice manipulations of user's voice, speech recognition, automatic voice diminishment when voice is detected, recording and playback of user's voice or any other sounds, and many other enhancement features.

The apparatus as above, wherein the adapter device can be operated with or without power source and power source may be drawn from its built-in battery, media player's power source, or any other power sources.

A method and apparatus for assisting phone user to play and inject sound effects to phone conversations quickly and easily using a media player and phone comprising:

first connection to receive audio signal C from a media player, such as MP3 player and the like;

a second connection to receive audio signal B from a two-way communications device such as a cellular phone;

audio signal A is generated by user's voice through the microphone;

a coupling device, known as the adapter device, independent from the media player and two-way communications device, generates audio signals which comprising either audio signal C, B, or the combination of the two then transmitted to user's hands-free device such as earset, headphones; and audio signal C, A, or the combination of both then transmitted to the voice path of user's communications device where it's audible to the other party of parties on the phone conversation.

Method and apparatus as above, wherein audio signal C could be a song, a movie clip, sound effects, or any sounds.

Method and apparatus as above, wherein audio signal C can be heard by both the user and all parties on the phone conversation.

Method and apparatus as above, wherein the audio signal A may include user's voice or any sound captured through user's microphone when transmitting to the phone's voice path for the other party or parties to hear.

Method and apparatus as above, wherein the audio signal A may be distortion or enhancement of user's voice.

Method and apparatus as above, wherein the audio signal A may be command signals such as ANSWER/END a call, redial the last phone number, or any other signals can be sent to the phone. Method and apparatus as above, wherein the audio signal B may include, not just human voice, any sounds generated from the phone of the other party or parties on the line when transmitting to user's hands-free device such as headset, earset, or the like.

Method and apparatus as above, wherein audio signal transmissions between adapter device, phone, hands-free device, and media player further comprising variations of:

media player to adapter to both phone and hands-free device;

media player to adapter to phone to hands-free device;

media player to adapter to hands-free device to phone.

The apparatus as above, wherein the adapter device can be integrated or removably attached to: media player, phone, or hands-free device.

### ALTERNATIVE EMBODIMENTS

Although the above descriptions are specific, they should not be considered as limitations on the scope of the invention, but only as examples of the embodiments shown. Many other variations are possible within the teaching of the invention. For example:
Adapter devices may be in different shapes, for example, triangular, rectangular, or any other shape and they can also be in different colors and built with different materials, finishes, and sizes.
The connectors themselves may be a different type of plug, not restricted to only 2.5 mm and 3.5 mm jacks.
The wires for connecting to a media player, phone, and/or hands-free headset could be attached, retractable, or substituted with wireless connections such as Bluetooth, UltraWide Band (UWB), or other wireless technologies.
The earset could be a single earset with a mic like a typical hands-free headset on the market or it could be integrated with a pair of stereo headsets for music listening but also with a microphone built in.
Adapter devices can be wired, partial wired, and all wire-free as shown in FIG. 2B, 2C, and 2D, respectively.
In additional to Media (MP3) players, the adapter can be use on Computers, CD players, DVD players, portable video players, and other devices capable of audio playback.
Adapter devices may or may not include a volume controller.
Adapter devices may include features like automatic volume decrease or mute functionalities with speech sensor when an audio clip is playing.
Adapter devices may allow interchangeable color and design faceplates or caps.
Adapter may include a clip for clipping the unit on a shirt, pocket, and any other user's belonging.
The adapter device may provide an alert signal (visual and/or audio) for any incoming phone call while user is using the media player to listening to music.
The adapter device may include a record function to record any sound or voice for playback as well as any incoming audio from phone's output such as the other party or parties' voices.
Adapter device may consists one or more jacks for removably attached cables for connecting the adapter with phone and media player as well as the hands-free headset.
Integrated FM and/or AM radio as well as a voice recorder.
Adapter device may include a processor and any other required components for voice distortion, speech recognition, and any other enhancement features.

There are thus provided methods and devices that users will like to use, that provide entertainment and amusement, which will not interfere with phone conversations, which users can use to play sound clips of their choice according to their moment of thoughts, which have commercial value by being amusing, entertainment, unusual, and capable of producing a surprise effect as well as enabling users to have vivid and creative phone conversations. In different embodiments, the invention provides devices that are operable with, in addition to cellular phones, any land-wired phones and other communications devices 280. The adapter device 200 in accordance with the invention can be wired or wireless or a combination of both.

Further advantages include a device that is simple and economical, easy to put on and take off and pleasant and comfortable to use and carry. The invention enables consumers to maximize their investments in their cellular phones and media players by providing apparatuses, which simply connect their phone 280 and media player 270 to enable injection of audio clips and sound effects into their phone conversations.

There have thus been provided new and improved methods and systems that enable a user to inject sound clips from an audio device into a telephone conversation. The invention includes an adapter that connects to an audio player, a user listening device and a communication device such as a telephone. In different embodiments, these connections made be wired, wireless or a combination of both. The audio player may comprise, for example, an MP3 player or any other audio player suitable for operation with the present invention, typically being interchangeable and each player of the type capable of storing changeable sound clips. In operation, the user selects an audio clip from the audio device for substantially immediate and simultaneous playback through the user listening device and the telephone. In this manner, both the user and any other party to the telephone conversation can hear the audio clip substantially simultaneously. In different embodiments the invention may serve as an interface between a media player and a headset-telephone connection, or as an interface between each of the media player, headset and telephone. The invention thus enables all of the described benefits and advantages of providing useful and entertaining audio clips into telephone conversations using affordable, and in many instances already owned, equipment. The invention has application in both the fields of personal entertainment devices and communications.

Therefore, the scope of the invention should not be determined by the examples given, but only by the appended claims and their legal equivalents. It will be apparent to those skilled in the art that changes and modifications may be made in the embodiments illustrated, without departing from the spirit and the scope of the invention. Thus, the invention is not to be limited to the particular forms herein shown and described except insofar as indicated by the scope of the appended claims.

What is claimed is:

1. Apparatus for injecting audio clips into a telephone communication, comprising:
a first connection for connecting to a selected one of a plurality of audio playback devices, the selected audio playback device storing at least one audio clip;
at least a second connection for connecting to at least one of a telephone including a voice path and a headset including an earpiece;
an adapter, connected to each of the first and second connectors for receiving on the first connector an audio clip output by the selected audio playback device and for transmitting the audio clip substantially simultaneously on the second connector to the voice path of the telephone and to the earpiece of the headset.

2. The apparatus of claim 1 wherein the second connection is connected to the telephone and further including a third connection connected to the headset.

3. The apparatus of claim 2 wherein the headset includes a microphone and the adapter is further operative to, using the second and third connections, transmit audio communications between the headset and the telephone whereby a user can communicate with a third party on the telephone.

4. The apparatus of claim 1 wherein each of the first and second connections are selected from the group comprising a wired connection and a wireless connection.

5. The apparatus of claim 2 wherein each of the wired connections includes at least a cable and a connector attached to the cable.

6. The apparatus of claim 5 and further including a case housing the adapter and at least one retractor connected to the case for retracting a cable into the case.

7. The apparatus of claim 1 and further including:
a case housing the adapter; and
the adapter including an electronic circuit housed in the case, the electronic circuit including
a receiver for receiving the audio clip from a connection, an audio processor for processing the audio clip, a transmitter for outputting the audio clip onto a connection and a controller for controlling the operation of the adapter.

8. The apparatus of claim 1 wherein the audio player includes means for storing and playing a plurality of changeable audio clips and means operable by a user for selecting the audio clip from the plurality of audio clips.

9. The apparatus of claim 8 wherein the audio player is selected from the group comprising an MP3 player, a CD player, a computer, a DVD player and a portable video player.

10. The apparatus of claim 1 wherein the telephone is selected from the group comprising a cellular telephone and a landline telephone.

11. A system for injecting audio clips into a telephone communication, comprising:
a telephone;
an audio player including a first control operable by a user for storing a plurality of changeable audio clips and a second control operable by the user for selecting an audio clip from the plurality of changeable audio clips;
a headset including a microphone and an earpiece;
an adapter for processing the audio clip;
a first connection selectively connectable between the audio player and the adapter;
a second connection selectively connectable between the adapter and the telephone;
a third connection selectively connectable between the adapter and the headset;
the adapter including an electronic circuit comprising a receiver for receiving the selected audio clip from the audio player through the first connection, an audio processor for processing the audio clip, a transmitter for outputting the audio clip onto each of the second connection for transmission to the telephone and the third connection for transmission to the headset, and a controller for controlling the operation of the adapter; and
the adapter further operative to transmit audio from the headset microphone to a voice path of the telephone;
whereby the selected audio clip can be substantially simultaneously played back on both the headset and the telephone while the user communicates on the telephone using the headset.

12. A method of injecting audio clips into a telephone communication, comprising:
providing an adapter;
connecting the adapter to a selected one of a plurality of audio playback devices, the selected audio playback device storing at least one audio clip;
connecting the adapter to at least one of a telephone including a voice path and a headset including a microphone and an earpiece;
engaging in a telephone call on the telephone using the headset microphone to transmit audio and the headset earpiece to receive audio;
selecting the at least one audio clip; and
transmitting, using the adapter, the audio clip to the telephone and to the headset whereby the audio clip can be heard substantially simultaneously by all parties to the telephone call.

13. The method of claim 12 wherein the connecting the adapter to at least one of a telephone and the headset includes connecting the adapter to each of the telephone and the headset and further including:
receiving audio from the headset microphone into the adapter and transmitting the received headset microphone audio from the adapter to the voice path of the telephone; and
receiving audio from the telephone into the adapter and transmitting the received telephone audio from the adapter to the headset.

14. The method of claim 13 wherein the headset is a wireless headset and further including the step of pairing the wireless headset with the adapter whereby the headset and adapter can communicate.

15. The method of claim 13 wherein each of the steps of connecting the adapter is selected from the group comprising connecting with a wire and connecting wirelessly.

16. The method of claim 15 wherein each of the wired connections includes at least a cable and a connector attached to the cable.

17. The method of claim 12 and further including:
providing a case for housing the adapter; and
the case optionally including a retractor for retracting wired connectors into the case.

18. The method of claim 12 wherein the selected audio playback includes means for receiving and storing a plurality of changeable audio clips and means operable by a user for selecting the at least one audio clip from the plurality of audio clips.

19. The method of claim 18 wherein the selected audio playback device is selected from the group comprising an MP3 player, a CD player, a computer, a DVD player and a portable video player.

20. The method of clam 12 wherein the telephone is selected from the group comprising a cellular telephone and a landline telephone.

21. Apparatus for injecting audio clips into a telephone communication, comprising:
a first connection to an audio playback device, the selected audio playback device storing at least one changeable audio clip;
a second connection for connecting to at least one of a telephone including a voice path and a headset including an earpiece;
an adapter, connected to each of the first and second connectors for receiving on the first connector an audio clip output by the selected audio playback device and for transmitting the audio clip substantially simultaneously on the second connector to the voice path of the telephone and to the earpiece of the headset.

22. The apparatus of claim 21 wherein the adapter is integrated as a unit into one of the group comprising the audio playback device and the telephone and a headset.
